(19) United States
(12) Patent Application Publication
(10) Pub. No.: US 2006/0070640 A1
(43) Pub. Date: Apr. 6, 2006

(54) Method and system for injecting chemistry into a supercritical fluid

(76) Inventors: Darko Babic, Chandler, AZ (US); Carl L. White, Gilbert, AZ (US); Wayne M. Parent, Gilbert, AZ (US)

Correspondence Address: WOOD, HERRON & EVANS, LLP (TOKYO ELECTRON), 2700 CAREW TOWER, 441 VINE STREET, CINCINNATI, OH, 45202, US

(21) Appl. No.: 10/957,417

(22) Filed: Oct. 1, 2004

(51) Int. Cl. C23G 1/00; B08B 7/04; B08B 7/00; B08B 3/12; B08B 3/00

(52) U.S. Cl. 134/42; 134/10; 134/2; 134/184; 134/201

(57) ABSTRACT

A method and system is described for introducing chemistry into a high pressure fluid for treating a substrate. In particular, the method includes dispersing the chemistry throughout the volume of high pressure fluid in order to promote mixing of the two or more fluids, while the high pressure fluid is circulating through a high pressure processing system.

This application is related to U.S. patent applications filed as Express Mail Nos.: EV536052737US, EV536052723US and EV536052754US, all filed on Sep. 30, 2004, hereby expressly incorporated by reference herein.

### BACKGROUND OF THE INVENTION

1. Field of the Invention

The present invention relates to a method and apparatus for providing a homogeneous processing environment in a high pressure processing system and, more particularly, to a method and apparatus for mixing a high pressure fluid and a process additive during exposure to a substrate in a high pressure processing system.

2. Description of Related Art

During the fabrication of semiconductor devices for integrated circuits (ICs), a critical processing requirement for processing semiconductor devices is cleanliness. The processing of semiconductor devices includes vacuum processing, such as etch and deposition processes whereby material is removed from or added to a substrate surface, as well as atmospheric processing, such as wet cleaning whereby contaminants or residue accumulated during processing are removed. For example, the removal of residue, such as photoresist, hardened photoresist, post-etch residue, and post-ash residue subsequent to the etching of features, such as trenches or vias, can utilize dry plasma ashing with an oxygen plasma followed by wet cleaning.

Until recently, dry plasma ashing and wet cleaning were found to be sufficient for removing residue and contaminants accumulated during semiconductor processing. However, recent advancements for ICs include a reduction in the critical dimension for etched features below a feature dimension acceptable for wet cleaning, such as a feature dimension below 45 to 65 nanometers, as well as the introduction of new materials, such as low dielectric constant (low-k) materials, which are susceptible to damage during plasma ashing.

Therefore, at present, interest has developed for the replacement of dry plasma ashing and wet cleaning. One interest includes the development of dry cleaning systems utilizing a supercritical fluid as a carrier for a process additive, such as a solvent or other residue removing composition. Post-etch and post-ash cleaning are examples of such systems. Other interests include other processes and applications that can benefit from the properties of supercritical fluids, particularly of substrates having features with a dimension of 65 nm, or 45 nm, or smaller. Such processes and applications may include restoring low dielectric films after etching, sealing porous films, drying of applied films, depositing materials, as well as other processes and applications. At present, the inventors have recognized that conventional high pressure processing systems offer insufficient control of the introduction of the process additive to the supercritical fluid which leads to a non-homogeneous processing environment during treatment of a substrate. Consequently, the substrate is exposed to variations in the concentration of the process additive that can cause excessive cleaning and potential damage at times, as well as poor cleaning at other times.

### SUMMARY OF THE INVENTION

One aspect of the invention is to reduce or eliminate any or all of the above-described problems.

Another object of the invention is to provide a method and system for providing a homogeneous processing environment in a high pressure processing system.

Another object of the invention is to provide a method and system for mixing a high pressure fluid and a process additive in a high pressure processing system.

According to one aspect, a high pressure processing system for treating a substrate is described comprising: a processing chamber configured to treat the substrate with a high pressure fluid, introduced therein, having substantially supercritical fluid properties; a high pressure fluid supply system configured to introduce a high pressure fluid to the processing chamber; a recirculation system coupled to the processing chamber and forming a circulation loop with the processing chamber, wherein the recirculation system is configured to circulate the high pressure fluid through the processing chamber over the substrate; and a process chemistry supply system having an injection system configured to introduce a process chemistry to the processing chamber, wherein the injection system introduces the process chemistry for an injection time duration substantially equivalent to a circulation time for the high pressure fluid to pass through the circulation loop.

According to another aspect, a method of processing a substrate in a high pressure processing system is described comprising: supplying a high pressure fluid for use in the high pressure processing system; circulating the high pressure fluid through the high pressure processing system; and introducing a process chemistry to the high pressure fluid while the high pressure fluid is circulating, wherein an injection time for introducing the process chemistry is substantially equivalent to a time duration for the high pressure fluid to circulate one cycle through the high pressure processing system.

According to another aspect, a method is described of introducing a relatively low number of particles in a high pressure processing system for treating a substrate comprising: introducing into a processing chamber a high pressure fluid having substantially supercritical fluid properties and treating a substrate by flowing said fluid over said substrate, then further introducing said fluid having substantially homogeneous, added process chemistry into said chamber, and flowing said further introduced fluid having said added process chemistry over said substrate.

### BRIEF DESCRIPTION OF THE DRAWINGS

In the accompanying drawings:

FIG. 1 presents a simplified schematic representation of a high pressure processing system according to an embodiment of the invention;

FIG. 2 presents a simplified schematic representation of a high pressure processing system according to another embodiment of the invention;

FIG. 3 presents a simplified schematic representation of an injection system according to an embodiment of the invention;

FIG. 4 presents a simplified schematic representation of an injection system according to another embodiment of the invention;

FIG. 5 presents a simplified schematic representation of an injection system according to another embodiment of the invention; and

FIG. 6 illustrates a method of processing a substrate in a high pressure processing system according to an embodiment of the invention.

FIG. 7 illustrates a method for injecting process chemistry into a high pressure fluid stream.

### DETAILED DESCRIPTION OF EXEMPLARY EMBODIMENTS

In the following description, to facilitate a thorough understanding of the invention and for purposes of explanation and not limitation, specific details are set forth, such as a particular geometry of the high pressure processing system and various descriptions of the system components. However, it should be understood that the invention may be practiced with other embodiments that depart from these specific details.

Nonetheless, it should be appreciated that, contained within the description are features which, notwithstanding the inventive nature of the general concepts being explained, are also of an inventive nature.

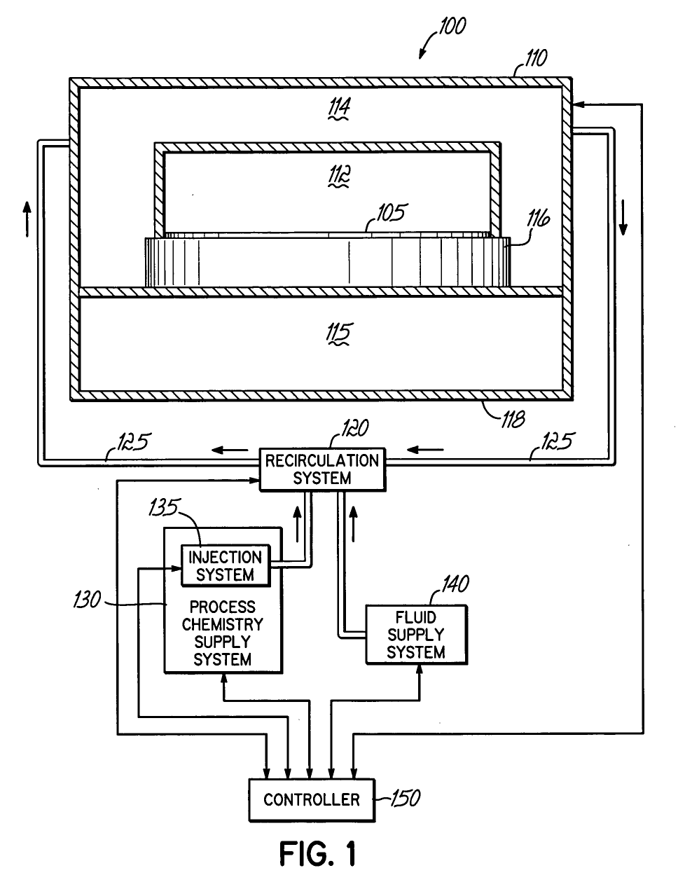

Referring now to the drawings, wherein like reference numerals designate identical or corresponding parts throughout the several views, FIG. 1 illustrates a high pressure processing system 100 according to an embodiment of the invention. In the illustrated embodiment, high pressure processing system 100 comprises processing elements that include a processing chamber 110, a recirculation system 120, a process chemistry supply system 130, a high pressure fluid supply system 140, and a controller 150, all of which are configured to process substrate 105. The controller 150 can be coupled to the processing chamber 110, the recirculation system 120, the process chemistry supply system 130, and the high pressure fluid supply system 140. Alternately, or in addition, controller 150 can be coupled to a one or more additional controllers/computers (not shown), and controller 150 can obtain setup and/or configuration information from an additional controller/computer.

In FIG. 1, singular processing elements (110, 120, 130, 140, and 150) are shown, but this is not required for the invention. The high pressure processing system 100 can comprise any number of processing elements having any number of controllers associated with them in addition to independent processing elements.

The controller 150 can be used to configure any number of processing elements (110, 120, 130, and 140), and the controller 150 can collect, provide, process, store, and display data from processing elements. The controller 150 can comprise a number of applications for controlling one or more of the processing elements. For example, controller 150 can include a graphic user interface (GUI) component (not shown) that can provide easy to use interfaces that enable a user to monitor and/or control one or more processing elements.

Referring still to FIG. 1, the recirculation system 120 can include one or more valves for regulating the flow of a high pressure processing solution through the recirculation system 120 and through the processing chamber 110. The recirculation system 120 can comprise any number of back-flow valves, filters, pumps, and/or heaters (not shown) for maintaining a high pressure processing solution and flowing the high pressure process solution through the recirculation system 120 and through the processing chamber 110.

Referring still to FIG. 1, the high pressure processing system 100 can comprise high pressure fluid supply system 140. The high pressure fluid supply system 140 can be coupled to the recirculation system 120, but this is not required. In alternate embodiments, high pressure fluid supply system supply system 140 can be configured differently and coupled differently. For example, the high pressure fluid supply system 140 can be coupled to the processing chamber 110. The fluid supply system 140 can include a supercritical fluid supply system. A supercritical fluid as referred to herein is a fluid that is in a supercritical state, which is that state that exists when the fluid is maintained at or above the critical pressure and at or above a critical temperature on its phase diagram, which pressure is typically also temperature dependent. In such a supercritical state, the fluid possesses certain properties, one of which is the substantial absence of a surface tension. Accordingly, a supercritical fluid supply system, as referred to herein, is one that delivers to a processing chamber a fluid that assumes a supercritical state at the pressure and temperature at which the processing chamber is being controlled. Furthermore, it is only necessary that at least at or near the critical point so that the fluid is in a substantially supercritical state at which its properties are sufficient, and exist long enough, to realize their advantages in the process being performed. Carbon dioxide, for example, is a supercritical fluid when maintained at or above a pressure of about 1070 psi at a temperature of 31 degrees C., a pressure that varies inversely with temperature. This state of the fluid in the processing chamber may be maintained by operating the chamber at 2,000 to 6,000 psi at a temperature of between 60 and 100 degrees C., for example.

The high pressure fluid supply system 140 can include a supercritical fluid supply system, which can be a carbon dioxide supply system. The high pressure fluid supply system 140 can be configured to introduce a high pressure fluid having a pressure substantially near the critical pressure for the fluid. Additionally, the high pressure fluid supply system 140 can be configured to introduce a supercritical fluid, such as carbon dioxide in a supercritical state. Examples of other supercritical fluid species useful in the broad practice of the invention include, but are not limited to, carbon dioxide (as described above), oxygen, argon, krypton, xenon, ammonia, methane, methanol, dimethyl ketone, hydrogen, and sulfur hexafluoride. The high pressure fluid supply system can, for example, comprise a carbon dioxide source (not shown) and a plurality of flow control elements (not shown) for generating a supercritical fluid. For example, the carbon dioxide source can include a CO₂ feed system, and the flow control elements can include supply lines, valves, filters, pumps, and heaters. The high pressure fluid supply system 140 can comprise an inlet valve (not shown) that is configured to open and close to allow or prevent the stream of supercritical carbon dioxide from flowing into the processing chamber 110. For example, controller 150 can be used to determine fluid parameters such as pressure, temperature, process time, and flow rate.

Referring still to FIG. 1, the process chemistry supply system 130 is coupled to the recirculation system 120, but this is not required for the invention. In alternate embodiments, the process chemistry supply system 130 can be coupled to the processing chamber 110. Alternatively, the process chemistry supply system 130 can be coupled to different elements in the high pressure processing system 100. The process chemistry is introduced by the process chemistry supply system 130 into the fluid introduced by the fluid supply system 140 at ratios that vary with the substrate properties, the chemistry being used and the process being performed in the chamber. Usually the ratio is roughly 1 to 5 percent by volume, which, for a chamber, recirculation system and associated plumbing having a volume of about 1 liter amounts to about 10 to 50 milliliter of additive in most cases, but the ratio may be higher or lower.

The process chemistry supply system 130 can be configured to introduce one or more of the following process compositions, but not limited to: cleaning compositions for removing contaminants, residues, hardened residues, photoresist, hardened photoresist, post-etch residue, post-ash residue, post chemical-mechanical polishing (CMP) residue, post-polishing residue, or post-implant residue, or any combination thereof; cleaning compositions for removing particulate; drying compositions for drying thin films, porous thin films, porous low dielectric constant materials, or air-gap dielectrics, or any combination thereof; film-forming compositions for preparing dielectric thin films, metal thin films, or any combination thereof; or any combination thereof. Additionally, the process chemistry supply system 130 can be configured to introduce solvents, co-solvents, surfactants, film-forming precursors, or reducing agents, or any combination thereof.

The process chemistry supply system 130 can be configured to introduce N-Methyl Pyrrolidone (NMP), diglycol amine, hydroxylamine, di-isopropyl amine, tri-isoprpyl amine, tertiary amines, catechol, ammonium fluoride, ammonium bifluoride, methylacetoacetamide, ozone, propylene glycol monoethyl ether acetate, acetylacetone, dibasic esters, ethyl lactate, CHF₃, BF₃, HF, other fluorine containing chemicals, or any mixture thereof. Other chemicals such as organic solvents may be utilized independently or in conjunction with the above chemicals to remove organic materials. The organic solvents may include, for example, an alcohol, ether, and/or glycol, such as acetone, diacetone alcohol, dimethyl sulfoxide (DMSO), ethylene glycol, methanol, ethanol, propanol, or isopropanol (IPA). For further details, see U.S. Pat. No. 6,306,564B1, filed May 27, 1998, and titled “REMOVAL OF RESIST OR RESIDUE FROM SEMICONDUCTORS USING SUPERCRITICAL CARBON DIOXIDE”, and U.S. Pat. No. 6,509,141B2, filed Sep. 3, 1999, and titled “REMOVAL OF PHOTORESIST AND PHOTORESIST RESIDUE FROM SEMICONDUCTORS USING SUPERCRITICAL CARBON DIOXIDE PROCESS,” both incorporated by reference herein.

Additionally, the process chemistry supply system 130 can comprise a cleaning chemistry assembly (not shown) for providing cleaning chemistry for generating supercritical cleaning solutions within the processing chamber. The cleaning chemistry can include peroxides and a fluoride source. For example, the peroxides can include hydrogen peroxide, benzoyl peroxide, or any other suitable peroxide, and the fluoride sources can include fluoride salts (such as ammonium fluoride salts), hydrogen fluoride, fluoride adducts (such as organo-ammonium fluoride adducts), and combinations thereof. Further details of fluoride sources and methods of generating supercritical processing solutions with fluoride sources are described in U.S. patent application Ser. No. 10/442,557, filed May 20, 2003, and titled “TETRA-ORGANIC AMMONIUM FLUORIDE AND HF IN SUPERCRITICAL FLUID FOR PHOTORESIST AND RESIDUE REMOVAL”, and U.S. patent application Ser. No. 10/321,341, filed Dec. 16, 2002, and titled “FLUORIDE 1N SUPERCRITICAL FLUID FOR PHOTORESIST POLYMER AND RESIDUE REMOVAL,” both incorporated by reference herein.

Furthermore, the process chemistry supply system 130 can be configured to introduce chelating agents, complexing agents and other oxidants, organic and inorganic acids that can be introduced into the supercritical fluid solution with one or more carrier solvents, such as N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate, and alcohols (such a methanol, ethanol and 2-propanol).

Moreover, the process chemistry supply system 130 can comprise a rinsing chemistry assembly (not shown) for providing rinsing chemistry for generating supercritical rinsing solutions within the processing chamber. The rinsing chemistry can include one or more organic solvents including, but not limited to, alcohols and ketone. In one embodiment, the rinsing chemistry can comprise sulfolane, also known as thiocyclopenatne-1,1-dioxide, (Cyclo) tetramethylene sulphone and 2,3,4,5-tetrahydrothiophene-1,1-dioxide, which can be purchased from a number of venders, such as Degussa Stanlow Limited, Lake Court, Hursley Winchester SO21 2LD UK.

Moreover, the process chemistry supply system 130 can be configured to introduce treating chemistry for curing, cleaning, healing, or sealing, or any combination, low dielectric constant films (porous or non-porous). The chemistry can include hexamethyldisilazane (HMDS), chlorotrimethylsilane (TMCS), or trichloromethylsilane (TCMS). For further details, see U.S. patent application Ser. No. 10/682,196, filed Oct. 10, 2003, and titled “METHOD AND SYSTEM FOR TREATING A DIELECTRIC FILM,” and U.S. patent application Ser. No. 10/379,984, filed Mar. 4, 2003, and titled, “METHOD OF PASSIVATING LOW DIELECTRIC MATERIALS IN WAFER PROCESSING,” both incorporated by reference herein.

The processing chamber 110 can be configured to process substrate 105 by exposing the substrate 105 to high pressure fluid from the high pressure fluid supply system 140, or process chemistry from the process chemistry supply system 130, or a combination thereof in a processing space 112. Additionally, processing chamber 110 can include an upper chamber assembly 114, and a lower chamber assembly 115. For example, the high pressure processing system can include a processing chamber similar to the system described in pending U.S. patent application Ser. No. 09/912,844 (US Patent Application Publication No. 2002/0046707 A1), entitled “High pressure processing chamber for semiconductor substrates”, and filed on Jul. 24, 2001, which is incorporated herein by reference in its entirety.

When a substrate is processed in the processing chamber 110, high pressure fluid can be introduced to the processing chamber, and circulated through the processing chamber 110 via the recirculation system 120. The combination of the processing chamber 110 and the recirculation system 120 comprises a circulation loop 125 through which the high pressure fluid passes. Depending on the flow rate, the high pressure fluid requires a circulation time duration characteristic of the design of the processing chamber 110 and recirculation system 120 to perform one cycle through the circulation loop 125.

While high pressure fluid is circulated through the processing chamber 110, process chemistry is introduced to the flowing high pressure fluid from the process chemistry system 130 through an injection system 135 configured to inject the process chemistry over a time duration substantially equivalent to the circulation time duration, or substantially equivalent to an integer number of circulation time durations. In one embodiment, the injection system 135 includes a metering pump, such as a model BBB-4 liquid metering pump (1-100 ml/min. at 5000 psi; with UHMWPE piston seal and #1424 PEEK check valve seals), commercially available from Eldex Laboratories, Inc., or a model HYM, commercially available from Fuji Techno Industries Corporation.

Referring still to FIG. 1, the upper chamber assembly 112 can comprise a heater (not shown) for heating the processing chamber 110, the substrate 105, or the processing fluid, or a combination of two or more thereof. Alternately, a heater is not required. Additionally, the upper chamber assembly can include flow components for flowing a processing fluid through the processing chamber 110. In one example, a circular flow pattern can be established, and in another example, a substantially linear flow pattern can be established. Alternately, the flow components for flowing the fluid can be configured differently to affect a different flow pattern.

The lower chamber assembly 115 can include a platen 116 configured to support substrate 105 and a drive mechanism 118 for translating the platen 116 in order to load and unload substrate 105, and seal lower chamber assembly 115 with upper chamber assembly 114. The platen 116 can also be configured to heat or cool the substrate 105 before, during, and/or after processing the substrate 105. Additionally, the lower assembly 115 can include a lift pin assembly for displacing the substrate 105 from the upper surface of the platen 116 during substrate loading and unloading.

A transfer system (not shown) can be used to move a substrate into and out of the processing chamber 110 through a slot (not shown). In one example, the slot can be opened and closed by moving the platen, and in another example, the slot can be controlled using a gate valve.

The substrate can include semiconductor material, metallic material, dielectric material, ceramic material, or polymer material, or a combination of two or more thereof. The semiconductor material can include Si, Ge, Si/Ge, or GaAs. The metallic material can include Cu, Al, Ni, Pb, Ti, and Ta. The dielectric material can include silica, silicon dioxide, quartz, aluminum oxide, sapphire, low dielectric constant materials, Teflon, and polyimide. The ceramic material can include aluminum oxide, silicon carbide, etc.

The processing system 100 can also comprise a pressure control system (not shown). The pressure control system can be coupled to the processing chamber 110, but this is not required. In alternate embodiments, the pressure control system can be configured differently and coupled differently. The pressure control system can include one or more pressure valves (not shown) for exhausting the processing chamber 110 and/or for regulating the pressure within the processing chamber 110. Alternately, the pressure control system can also include one or more pumps (not shown). For example, one pump may be used to increase the pressure within the processing chamber, and another pump may be used to evacuate the processing chamber 110. In another embodiment, the pressure control system can comprise seals for sealing the processing chamber. In addition, the pressure control system can comprise an elevator for raising and lowering the substrate and/or the platen.

Furthermore, the processing system 100 can comprise an exhaust control system. The exhaust control system can be coupled to the processing chamber 110, but this is not required. In alternate embodiments, exhaust control system can be configured differently and coupled differently. The exhaust control system can include an exhaust gas collection vessel (not shown) and can be used to remove contaminants from the processing fluid. Alternately, the exhaust control system can be used to recycle the processing fluid.

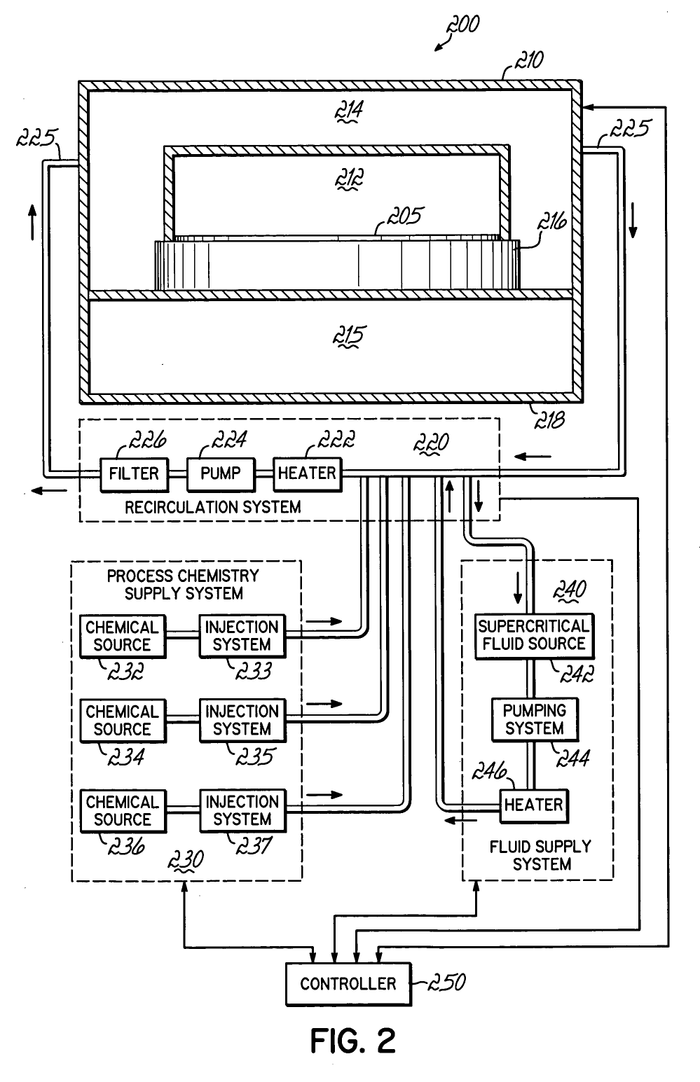

Referring now to FIG. 2, a high pressure processing system 200 is presented according to another embodiment. In the illustrated embodiment, high pressure processing system 200 comprises a processing chamber 210, a recirculation system 220, a process chemistry supply system 230, a high pressure fluid supply system 240, and a controller 250, all of which are configured to process substrate 205. The controller 250 can be coupled to the processing chamber 210, the recirculation system 220, the process chemistry supply system 230, and the high pressure fluid supply system 240. Alternately, controller 250 can be coupled to a one or more additional controllers/computers (not shown), and controller 250 can obtain setup and/or configuration information from an additional controller/computer.

As shown in FIG. 2, the recirculation system 220 can include a recirculation fluid heater 222, a pump 224, and a filter 226. Additionally, the process chemistry supply system 230 can include one or more chemistry introduction systems, each introduction system having a chemical source 232, 234, 236, and an injection system 233, 235, 237. The injection systems 233, 235, 237 can include a pump and an injection valve. Furthermore, the high pressure fluid supply system 240 can include a supercritical fluid source 242, a pumping system 244, and a supercritical fluid heater 246. Moreover, one or more injection valves, or exhaust valves may be utilized with the high pressure fluid supply system.

When a substrate is processed in the processing chamber 210, high pressure fluid can be introduced to the processing chamber, and circulated through the processing chamber 210 via the recirculation system 220. The combination of the processing chamber 210 and the recirculation system 220 comprises a circulation loop 225 through which the high pressure fluid passes. Depending on the flow rate, the high pressure fluid requires a circulation time duration characteristic of the design of the processing chamber 210 and recirculation system 220 to perform one cycle through the circulation loop 225.

While high pressure fluid is circulated through the processing chamber 210, process chemistry is introduced to the flowing high pressure fluid from the process chemistry system 230 through injection systems 233, 235, or 237, each of which is configured to inject the process chemistry over a time duration substantially equivalent to the circulation time duration.

In one embodiment, the injection system 233, 235, 237 includes a pulsed injection valve. The pulsed injection valve can include an electro-magnetic valve, such as a solenoidal valve, or piezo-electric valve. For example, the pulsed injection valve may include an automotive fuel injector valve or pulsed piezo-electric valve (e.g., piezo-electric actuated micro-machined valve); see, for example, injector valves commercially available from the Robert Bosch Corporation, or Cross & Valentini (1982), Bates & Burell (1984), and Gentry & Giese (1978), the contents of which are incorporated by reference. The pulsed injection heads can provide pulse durations shorter than a millisecond with a repetition rate (or pulse frequency) greater than 1 kHz. The pulse frequency, pulse duty cycle, or both can be tailored in order to provide optimal mixing between the high pressure fluid and the process chemistry.

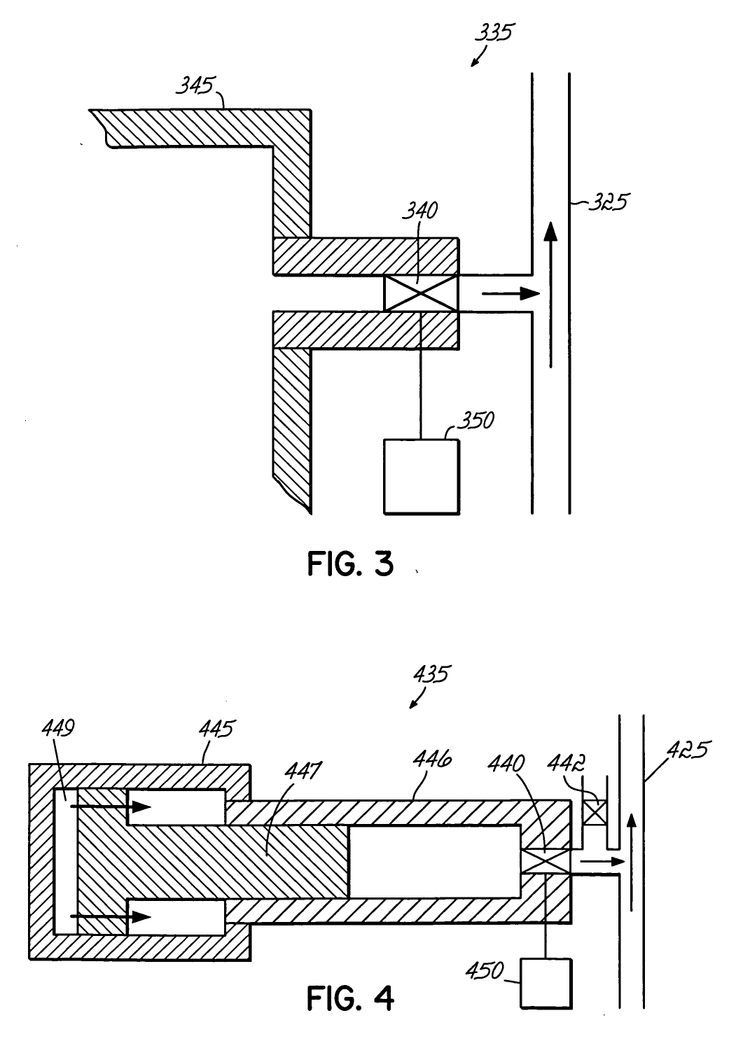

For instance, FIG. 3 illustrates one configuration for the use of a pulsed injection valve. As shown, the injection system 335 includes a pulsed injection valve 340 coupled to a high pressure supply reservoir 345, and configured to introduce process chemistry to the high pressure fluid in circulation loop 325. Controller 350 can be configured to alter the pulse frequency, or pulse duty cycle, or both.

Additionally, for instance, FIG. 4 illustrates another configuration for use of a pulsed injection valve. As shown, the injection system 435 includes a pulsed injection valve 440 coupled to a supply reservoir 446, and configured to introduce process chemistry to the high pressure fluid in circulation loop 425. The supply reservoir 446 can be energized (or pressurized) by pressurizing air space 449 within pneumatic pressure chamber 445, and actuating movement of piston 447. When the pulsed injection valve 440 is actuated and process chemistry is removed from the supply reservoir 446, the air space 449 can continue to be pressurized in order to maintain a constant pressure, and cause movement of the piston 447 into supply reservoir 446 until all of the process chemistry is depleted. Alternatively, the air space 449 can be de-pressurized, hence, withdrawing the piston 447 from supply reservoir 446, and filling supply reservoir 446 with fresh process chemistry when valve 442 is opened to a process chemistry supply system. Controller 450 can be configured to alter the pulse frequency, or pulse duty cycle, or both.

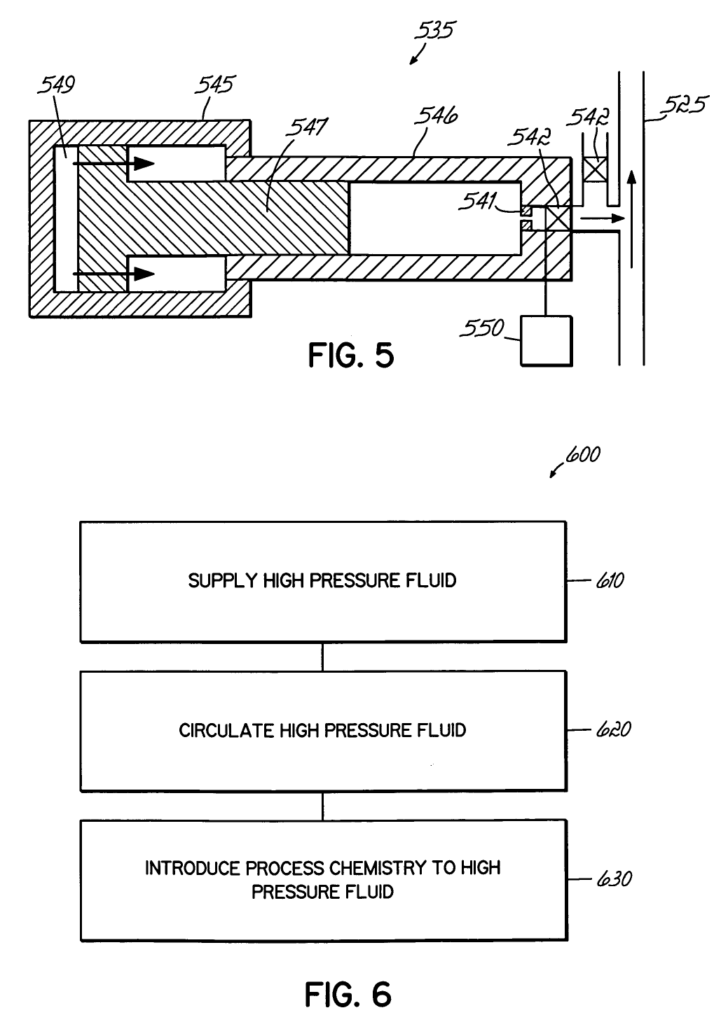

Alternatively, for instance, FIG. 5 illustrates another configuration for use of an injection system. As shown, the injection system 535 includes a injection valve 540 coupled to a supply reservoir 546, and configured to introduce process chemistry to the high pressure fluid in circulation loop 525. The supply reservoir 546 can be energized (or pressurized) by pressurizing air space 549 within pneumatic pressure chamber 545, and actuating movement of piston 547. When the injection valve 540 is opened and process chemistry is continuously removed from the supply reservoir 546, the air space 549 can continue to be pressurized in order to maintain a constant pressure, and cause movement of the piston 547 into supply reservoir 546 until all of the process chemistry is depleted. An orifice 541 is designed to provide sufficient resistance to the flow of process chemistry into the high pressure fluid, whereby the time to deplete the volume of process chemistry in the supply reservoir is substantially equivalent to the circulation time duration of the high pressure fluid in the circulation loop 550. Alternatively, the air space 549 can be de-pressurized, hence, withdrawing the piston 547 from supply reservoir 546, and filling supply reservoir 546 with fresh process chemistry when valve 542 is opened to a process chemistry supply system. Controller 550 can be configured to alter the pulse frequency, or pulse duty cycle, or both.

The mixing of the high pressure fluid and the process chemistry in the circulation loop can be monitored in order to determine the effectiveness of pulsed injection valve parameters (see FIGS. 3 and 4), or the design of the orifice depicted in FIG. 5. For example, a flow meter, such as a Coriolis meter, can be utilized to monitor the flow of high pressure fluid and process chemistry through the circulation loop. When flow variations (due to, for example, density variations) become less than a pre-determined value, the flow can be determined to be sufficiently mixed.

Referring now to FIG. 6, a method for processing a substrate in a high pressure processing system is described. The method includes a flow chart 600 beginning in 610 with supplying a high pressure fluid to the high pressure processing system.

In 620, the high pressure fluid is circulated through the high pressure processing system using a recirculation system.

In 630, a process chemistry, such as one described above, is supplied to the high pressure processing system, while the high pressure fluid is circulating in the high pressure processing system. The process chemistry is introduced during an injection time substantially equivalent to the circulation time duration for the high pressure fluid to complete one circulation cycle through the high pressure processing system.

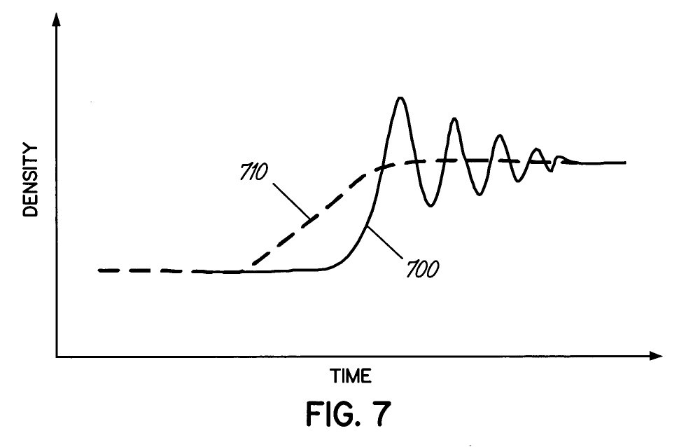

As an example, the inventors have observed that by injecting processing chemistry into a high pressure fluid stream, useful for cleaning a substrate, over a time scale substantially equivalent to a circulation time duration leads to improved cleaning performance, as well as reduced particle contamination of the substrate. FIG. 7 illustrates the conventional method by which process chemistry is introduced to the high pressure fluid stream. Therein, the injection period is substantially less than the circulation time, and as a result, a first time trace 700 of density is observed, wherein the density overshoots and then oscillates with decaying oscillations until it reaches a steady state value. For process chemistries having a high dissolution rate in the high pressure fluid, particle counts on the substrate are low, and cleaning performance is poor. However, for process chemistries having a low dissolution rate in the high pressure fluid, particle counts are high (>10,000) and can saturate the substrate, and the cleaning performance is acceptable.

Alternatively, as shown in FIG. 7, when the injection period is substantially equivalent to the circulation time, as described in embodiments above, a second trace 710 of density is observed, wherein the density gradually increases from a density without process chemistry to a steady state value. For process chemistries having a high dissolution rate, the injection time can be substantially equivalent to the circulation time, and as a result, very low particle counts on the substrate (<10) can be observed. Additionally, for process chemistries having a low dissolution rate, the injection time can be substantially equivalent to an integer number of the circulation time, and as a result, very low particle counts on the substrate can be observed and very good cleaning performance can be achieved. For instance, when using 5 ml metered injections of methanol and hydrogen peroxide (12:1 ratio), and 40 ml metered injections of methanol and hydrogen peroxide (12:1 ratio) at 2800 Psi and 80 degrees C., less than 10 particles per substrate have been observed and, for most cases, less than 1 particle per substrate has been observed.

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A high pressure processing system for treating a substrate comprising:
a processing chamber configured to treat said substrate with a high pressure fluid, introduced therein, having substantially supercritical fluid properties;
a high pressure fluid supply system configured to introduce a high pressure fluid to said processing chamber;
a recirculation system coupled to said processing chamber and forming a circulation loop with said processing chamber, wherein said recirculation system is configured to circulate said high pressure fluid through said processing chamber over said substrate; and
a process chemistry supply system having an injection system configured to introduce a process chemistry to said processing chamber, wherein said injection system introduces said process chemistry for an injection time duration substantially equivalent to a circulation time for said high pressure fluid to pass through said circulation loop, or substantially equivalent to an integer number of said circulation time.

2. The high pressure processing system of claim 1, wherein said high pressure fluid in said recirculation system includes a supercritical fluid.

3. The high pressure processing system of claim 2, wherein said supercritical fluid includes supercritical carbon dioxide (CO₂).

4. The high pressure processing system of claim 1, wherein said process chemistry supply system is configured to introduce a solvent, a co-solvent, a surfactant, a film-forming precursor, or a reducing agent, or any combination thereof.

5. The high pressure processing system of claim 1, wherein said process chemistry supply system is configured to introduce: cleaning compositions for removing contaminants, residues, hardened residues, photoresist, hardened photoresist, post-etch residue, post-ash residue, post chemical-mechanical polishing (CMP) residue, post-polishing residue, or post-implant residue, or any combination thereof; cleaning compositions for removing particulate; drying compositions for drying thin films, porous thin films, porous low dielectric constant materials, or air-gap dielectrics, or any combination thereof; film-forming compositions for preparing dielectric thin films, metal thin films, or any combination thereof; or any combination thereof.

6. The high pressure processing system of claim 1, wherein said injection system includes a pulsed injection valve.

7. The high pressure processing system of claim 6, wherein said pulsed injection valve operates with a pulse frequency and a pulse duty cycle.

8. The high pressure processing system of claim 7, further comprising:
a controller coupled to said injection system, and configured to adjust said pulse frequency, or said pulse duty cycle, or both.

9. The high pressure processing system of claim 1, wherein said injection system includes an injection valve, and an orifice designed to provide said injection time substantially equivalent to said circulation time duration.

10. The high pressure processing system of claim 1, wherein said injection system includes a metering pump.

11. A method of processing a substrate in a high pressure processing system comprising:
supplying a high pressure fluid for use in said high pressure processing system;
circulating said high pressure fluid through said high pressure processing system; and
introducing a process chemistry to said high pressure fluid while said high pressure fluid is circulating, wherein an injection time for introducing said process chemistry is substantially equivalent to a time duration for said high pressure fluid to circulate one cycle through said high pressure processing system.

12. The method of claim 11, wherein said supplying said high pressure fluid includes supplying a supercritical fluid.

13. The method of claim 12, wherein said supplying said supercritical fluid includes supplying supercritical carbon dioxide (CO₂).

14. A method of introducing a relatively low number of particles in a high pressure processing system for treating a substrate comprising:
introducing into a processing chamber a high pressure fluid having substantially supercritical fluid properties and treating a substrate by flowing said fluid over said substrate; then
further introducing said fluid having substantially homogeneous, added process chemistry into said chamber, and flowing said further introduced fluid having said added process chemistry over said substrate.

15. The method of claim 14 further comprising:
providing said fluid having substantially homogeneous, added process chemistry by introducing said process chemistry into said fluid, while circulating said fluid in a circulation loop that is configured to circulate said fluid through said processing chamber over said substrate, for an injection time duration substantially equivalent to a circulation time for said fluid to pass through said circulation loop or integral multiple thereof.

16. The method of claim 14 said fluid having substantially homogeneous is formed by adding process chemistry into said fluid, while flowing said fluid through said chamber, in a timed manner sufficient to reduce the number of particles added to said substrate during processing to less than approximately 100 particles.
